(19) United States
(12) Patent Application Publication
(10) Pub. No.: US 2013/0231985 A1
(43) Pub. Date: Sep. 5, 2013

(54) RELOADING OF MONEY-STORING CARDS IN SINGLE SPACE PARKING METERS

(71) Applicant: J.J. MACKAY CANADA LIMITED, New Glasgow (CA)

(72) Inventors: George Allan MacKay, New Glasgow (CA); Gregory Emile Chauvin, Brookside (CA); Neil Stuart Erskine, Halifax (CA)

(73) Assignee: J.J. MACKAY CANADA LIMITED, New Glasgow (CA)

(21) Appl. No.: 13/782,818

(22) Filed: Mar. 1, 2013

(30) Foreign Application Priority Data
Mar. 2, 2012 (CA) 2769983

(51) Int. Cl. G06Q 50/30; G06Q 20/34

(52) U.S. Cl. CPC G06Q 50/30; G06Q 20/34
USPC 705/13

(57) ABSTRACT

Improved single space parking meters capable of accepting payment from a card that stores a monetary amount are described. The single space parking meter includes functionality for reloading a monetary amount to a parking card. The single space parking meter may read account information from the payment card using the card reader and receive an indication of the monetary value to load or reload onto the parking card. The parking meter may communicate with a remote system to authorize a transaction using the payment card's account information for the monetary value. An indication of whether the transaction of the payment card was successful or not is received at the parking meter and the parking meter attempts to load or reload the monetary value to the parking card when the transaction was successful.

### TECHNICAL FIELD

The current application relates to single space parking meters and in particular to single space parking meters capable of accepting payment from a card that stores and may be reloaded with a monetary amount.

### BACKGROUND

Parking meters come in many shapes and sizes but are generally divided into two main types or classes: multi-space parking meters which are typically larger devices capable of managing the parking payment and control for typically six or more, or possibly even hundreds of parking spaces; and, single-space parking meters which are typically small devices capable of managing the parking payment and control of a single parking space, but also sometimes additional spaces, such as two, four, or six spaces which are located in close proximity to the parking meter. Multi-space meters are distinguishable from single space parking meters at least with respect to the physical limitations of the typical housings, with multi-space meters typically being housed in relatively large cabinets and single space parking meters being housed in typically compact enclosures mounted on poles. Multi-space meters may be further distinguishable from single space parking meters at least with respect to the input controls, ability to provide receipts, arrangement of internal mechanisms and components vis-à-vis a protective housing, and there being relatively much fewer multi-space meters as compared to single space meters.

FIG. 1 depicts a conventional single space parking meter mo installed on a pole 102. Single space parking meter mechanisms are typically installed in a protective housing on a pole 102 near a parking space or spaces being metered. The protective housing, which is directly exposed to the elements and the public, is traditionally separate from the actual removable parking meter mechanism; however, portions of the protective housing may be attached or otherwise coupled to the removable parking meter mechanism. The components or portions of the protective housing of single space parking meters 100 typically comprise a lower housing 104 that receives a removable parking meter mechanism and a cover 106 that encloses the parking meter mechanism. Single space parking meters typically include a coin vault 108 that holds coins inserted into the parking meter. Single space parking meters may accept coins for payment as well as cards, which store a monetary amount that can be debited for payment, or cards that store account information that can be processed for payment. The cards may be used by inserting the card into the single space parking meter, which communicates with the card to debit the payment amount from the card or reads the account information and communicates it to a backend system for further processing.

The use of cards for payment at single space parking meters provides a convenient payment means for users; however, reloading monetary value onto a card that stores a monetary amount may be inconvenient since it may require a user to go in person to an authorized station or central office that is remote from the single space parking meter(s) in order to make a payment and have the card reloaded accordingly. Thus, it is desirable to have a convenient means for reloading a card that stores a monetary amount with money at a single space parking meter.

### SUMMARY

In accordance with the present disclosure there is provided a removable single space parking meter mechanism comprising a card reader for reading a payment card, and reading from and writing to a parking card a monetary value; a communication module for communicating with a remote system; a memory for storing instructions; and a processor for executing the instructions. When executed by the processor, the instructions configure the removable parking meter mechanism to provide a method of loading or reloading the monetary value to the parking card. The method comprises reading account information from the payment card using the card reader; receiving an indication of the monetary value to load or reload onto the parking card; communicating with the remote system using the communication module to authorize a transaction using the payment card's account information for the monetary value; receiving an indication of whether the transaction of the payment card was successful or not; and attempting to load or reload the monetary value to the parking card when the transaction was successful.

In accordance with the present disclosure there is further provided a single space parking meter comprising a removable single space parking meter mechanism; and a protective housing protecting the parking meter mechanism from the environment. The removable single space parking meter mechanism comprising a card reader for reading a payment card, and reading from and writing to a parking card a monetary value; a communication module for communicating with a remote system; a memory for storing instructions; and a processor for executing the instructions. When executed by the processor, the instructions configure the removable parking meter mechanism to provide a method of loading or reloading the monetary value to the parking card. The method comprises reading account information from the payment card using the card reader; receiving an indication of the monetary value to load or reload onto the parking card; communicating with the remote system using the communication module to authorize a transaction using the payment card's account information for the monetary value; receiving an indication of whether the transaction of the payment card was successful or not; and attempting to load or reload the monetary value to the parking card when the transaction was successful.

In accordance with the present disclosure there is further provided a parking meter system comprising a plurality of single space parking meters; a parking management system capable of wirelessly communicating with the plurality of single space parking meters, the parking management system storing transaction information uniquely identifying transactions carried out at one or more of the plurality of single space parking meters; and a portal system for receiving identifying information for identifying a transaction in the transaction information and generating a receipt of the identified transaction. Each of the plurality of single space parking meters comprising a removable single space parking meter mechanism; and a protective housing protecting the parking meter mechanism from the environment. The removable single space parking meter mechanism comprising a card reader for reading a payment card, and reading from and writing to a parking card a monetary value; a communication module for communicating with a remote system; a memory for storing instructions; and a processor for executing the instructions. When executed by the processor, the instructions configure the removable parking meter mechanism to provide a method of loading or reloading the monetary value to the parking card. The method comprises reading account information from the payment card using the card reader; receiving an indication of the monetary value to load or reload onto the parking card; communicating with the remote system using the communication module to authorize a transaction using the payment card's account information for the monetary value; receiving an indication of whether the transaction of the payment card was successful or not; and attempting to load or reload the monetary value to the parking card when the transaction was successful.

In accordance with the present disclosure there is further provided a method for providing a transaction receipt for a single space parking meter. The method comprises carrying out a transaction at a single space parking meter, whereby the transaction is associated with transaction information uniquely identifying the transaction; communicating the transaction information to a remote server; storing the transaction information; receiving a request for a transaction receipt, the request comprising at least a portion of the transaction information uniquely identifying the transaction; retrieving the transaction information based on the portion of the transaction information received with the request; generating the transaction receipt from the retrieved transaction information; and providing the transaction receipt.

### BRIEF DESCRIPTION OF THE FIGURES

Further features and advantages will become apparent from the following detailed description, taken in combination with the appended drawings, in which:

FIG. 1 depicts a conventional single space parking meter installed on a pole;

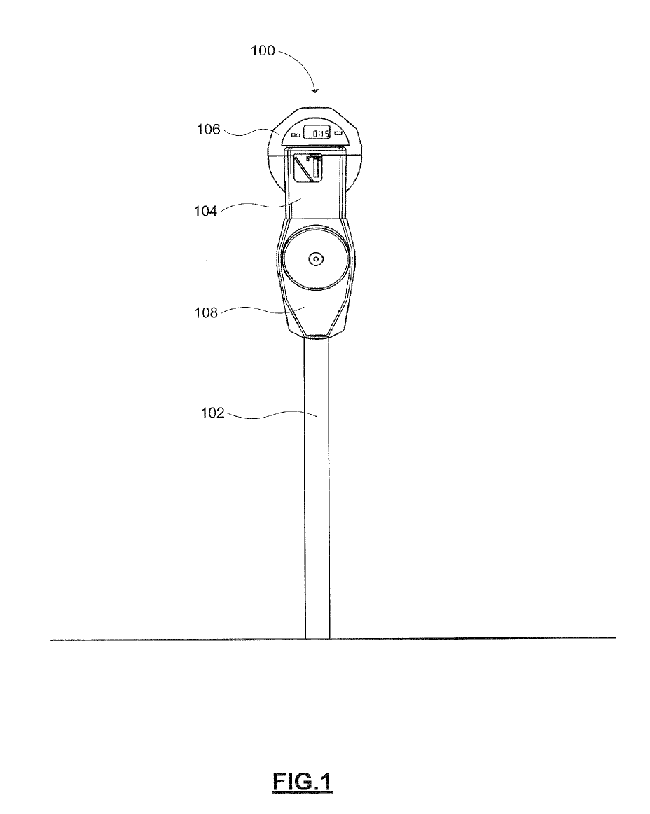

FIG. 2 depicts an illustrative single space parking meter;

FIG. 3 depicts the parking meter of FIG. 2 with the mechanism removed from the lower housing;

FIG. 4 depicts components of a single space parking meter capable of reloading a parking card;

FIG. 5 depicts components of a single space parking meter capable of reloading a parking card; and

FIG. 6 depicts a system for providing a transaction receipt of a transaction carried out at a parking meter.

### DETAILED DESCRIPTION

Single space parking meters may comprise a removable meter mechanism that is received within a protective housing mounted in a street location. The removable meter mechanism, or simply the mechanism, includes necessary components for providing metering functionality for parking spaces and may be removed from the housing, for replacement, repair or inspection. Single space parking meter mechanisms may include wireless communication capabilities, allowing for payments to be made using a card that requires communication with a remote server, or backend system, for authorization, such as a credit card. Single space parking meter mechanisms may also comprise functionality for accepting payment from a card that stores on the card a monetary amount available for payment. Such cards allow payment to be made by deducting a payment amount from the monetary amount stored on the card, and as such, payment can be made without requiring communication with a remote system to verify the payment. As described further herein, the removable mechanism may also comprise functionality for reloading a monetary value to a smart card.

As will be appreciated, various different types of cards may be referred to as smart cards. For example, debit cards, credit cards, reward cards, etc. may all use some form of chip or memory to store information. For clarity of the description, and without loss of generality, smart cards that store a monetary amount that can be deducted for payment will be referred to in the description as a parking card. It is noted that it is possible to include the functionality of the parking card in addition to the functionality of other smart cards such as credit cards or debit cards. Further, although referred to as a parking card, it is possible that the monetary value stored on the parking card may be used for other purposes. Similarly for the clarity of the description and without loss of generality, cards used for payments that require authorization from a remote system, including credit and debit cards, will be referred to in the description as payment cards.

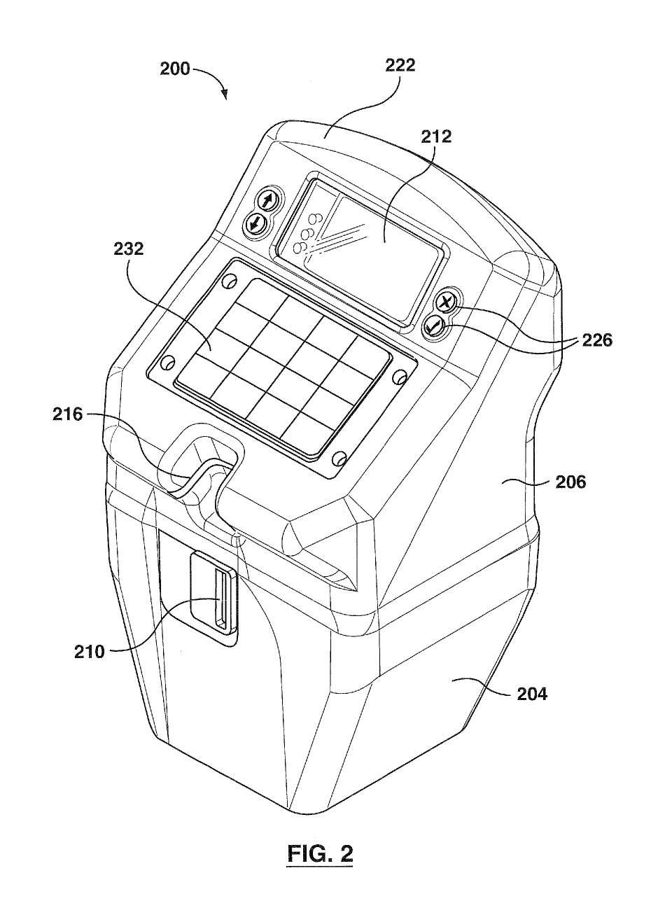

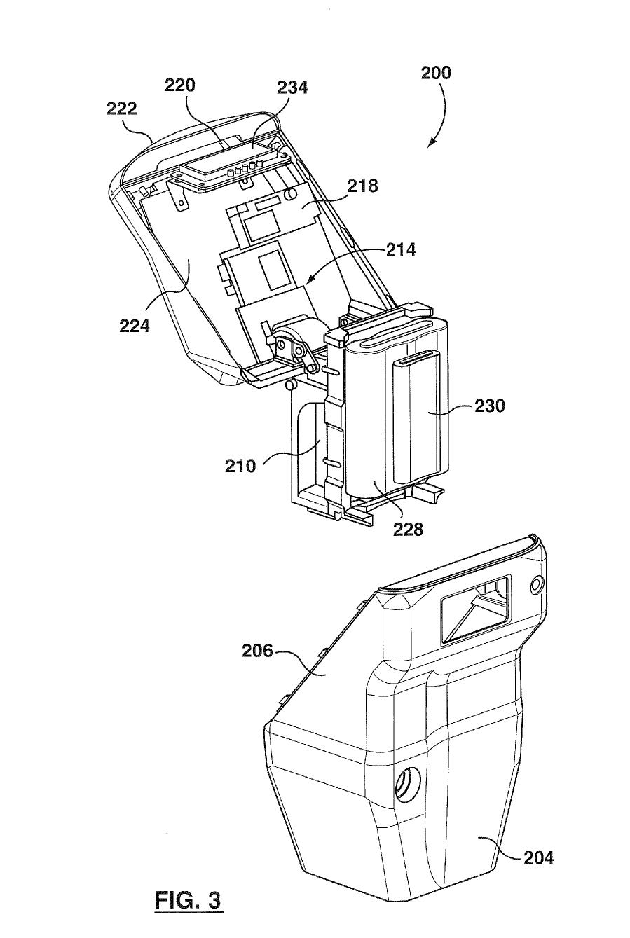

FIG. 2 depicts an illustrative single space parking meter. FIG. 3 depicts the parking meter of FIG. 2 with the mechanism removed from the lower housing. The single space parking meter 200 comprises a removable mechanism 202 coupled to a lower housing 204. The lower housing 204 may be mounted to a coin vault housing (not shown) which is generally mounted in close proximity to a parking spot being metered. The removable mechanism 202 may be secured to the lower housing 204 by a back housing 206. The removable mechanism 202 depicted comprises a front housing 208 portion of the housing of the parking meter 200. When the parking meter 200 is assembled as depicted in FIG. 2, the front housing 208, the back housing 206 and the lower housing 204 provide the housing that protects the internal components of the parking meter 200. It will be appreciated that different single space parking meters may have different mechanisms and/or housings; however the mechanisms typically have a common form factor to allow different mechanisms to be mounted within a lower housing having a standard form.

The parking meter zoo comprises metering components for providing metering functionality. The metering components may include, for example a coin chute and discriminator 210 for determining a denomination of a coin inserted into the parking metering, a display 212 for displaying information, a card module 214 for reading from and writing to a card inserted into a card slot 216 of the parking meter 200, and a communication module 218 for communicating with a remote system. The communication module 218 may provide wired or wireless communication with the remote system. If the communication module 218 provides wireless communication, it may be attached to an antenna 220 for transmitting and receiving RF signals. The wireless communication may be, for example, cellular communication such as CDMA, HSPA, GPRS or other types of cellular communication, WiFi communication, WiMax communication, Bluetooth communication or other RF communications. The antenna 220 may be located in various locations of the parking meter; however it is depicted as being located within an antenna cover 222 arranged at the top of the assembled parking meter 200. The metering components may further comprise a processor, memory and other components for operating the parking meter. The metering components may be mounted to a main printed circuit board (PCB) 224 mounted to the removable mechanism. The metering components may also comprise input components, such as buttons 226, four of which are depicted, which allow interaction with the parking meter.

Single space parking meters typically operate on battery power, although they may alternatively be wired to a mains electrical source. As depicted, the removable mechanism 202 may be provided with a main battery pack 228 as well as a backup battery pack 230. The single space parking meter 200 may also include a solar panel 232 for powering the components of the parking meter 200 and/or recharging the battery pack 228 and/or the backup battery pack 230.

The parking meter 200 may comprise additional components and/or features not described in detail herein. For example, an auxiliary display 234 may be provided on a back side of the parking meter 200, which may indicate “paid” or “unpaid” status to an enforcement officer. Further, although a particular implementation of a single space parking meter is described, it is contemplated that the reload functionality described herein may be provided in other single space parking meters that accept both a parking card and another type of payment card such as a credit card.

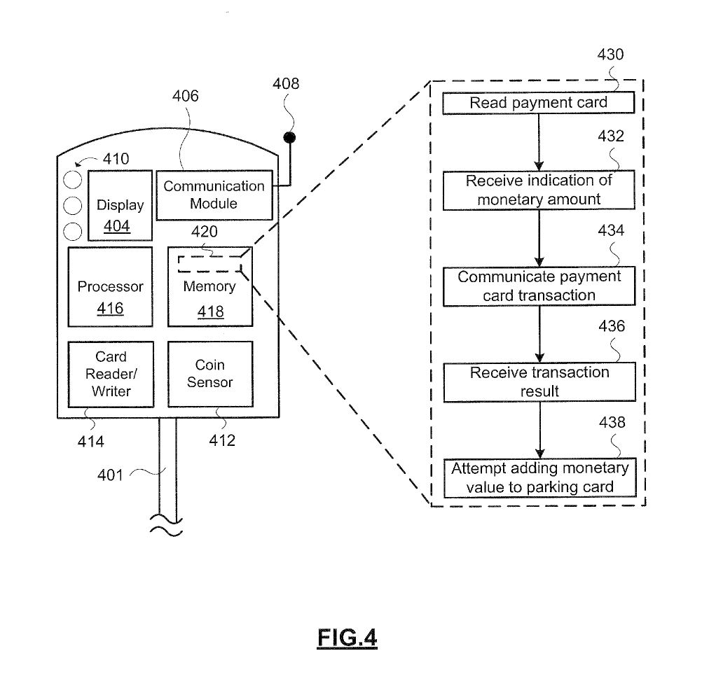

FIG. 4 depicts components of a single space parking meter capable of reloading a parking card. The parking meter 400 comprises a housing 402 for protecting components of the parking meter 400 from the environment. The housing 402 is generally mounted to a pole 401 at a parking location. The parking meter 400 comprises a display 404, a communication module 406 that is depicted as a wireless communication module 406 including antenna 408, a plurality of input components, such as buttons 410, a coin chute and coin discriminator 412, and a card reader/writer 414. The parking meter 400 further comprises a processor 416 and memory 418. The memory stores instructions 420 that when executed by the processor 416 configure the parking meter 400 to provide functionality for reloading of a parking card.

Parking time may be purchased at the parking meter 400 in various ways, including using coins, using a payment card that requires authorization of the transaction such as a credit card, and using a parking card that does not require authorization of the transaction, such as a smart card storing a monetary amount. When a parking card storing a monetary amount is used for payment, the value of the parking time purchased is debited from the parking card. It is possible to add a monetary amount to, or ‘reload’, a parking card at the single space parking meter using a payment card such as a credit card.

As depicted in FIG. 4, the parking meter 400 can be configured to provide functionality for reloading of the parking card. In order to provide the reload functionality, the parking meter 400 reads, or otherwise receives, account information from a payment card (430). The parking meter 400 may read the account information from the payment card, for example using a magnetic strip reader that reads the account information when the payment card is: swiped; inserted and removed; or inserted and read, in or by the card reader 414. The account information read, or received, by the parking meter 400 comprises the information required for processing a purchase transaction for the payment card. The account information may be temporarily stored in the parking meter 400 in order to complete the transaction. Once the account information has been received, an indication of the monetary amount that is to be added to the parking card is received (432). The indication of the monetary amount may be received in various ways, including through the use of the input components 410 to increase or decrease the monetary amount. Once the desired monetary amount to add to the parking card is received, the parking meter communicates the transaction information, including the monetary amount and the account information, to a backend system (434). The transaction information may further include additional information used for possibly identifying the transaction, such as a meter identification (ID) identifying the parking meter the transaction was made at and a date and time of the transaction at the parking meter. The backend system can further process the transaction to determine if the transaction is authorized or not. Once the backend system has determined if the transaction is authorized or not, the result is communicated back to the parking meter 400 which receives the transaction result information (436). In FIG. 4, it is assumed that the transaction is authorized and as such an attempt is made to add the authorized monetary amount to the parking card, which would be inserted into the parking meter 400, and more particularly in contact with the card reader/writer 414.

As described above, it is possible to use a single space parking meter to reload a parking card. As described, payment information is captured and a transaction for a desired monetary amount is processed. Then, for authorized transactions, the monetary amount of the transaction is added to the parking card. The parking card with the additional monetary amount may be subsequently used to pay for parking time at one or more parking meters. Although the single space parking meter described includes wireless functionality allowing for convenient payment by credit card, it may still be desirable to provide for payment using a parking card for various reasons. For example, using a parking card may be: simpler for managing parking expenses for accounting and/or tax purposes; simpler for identifying expenses for reimbursement; or a matter of personal preference.

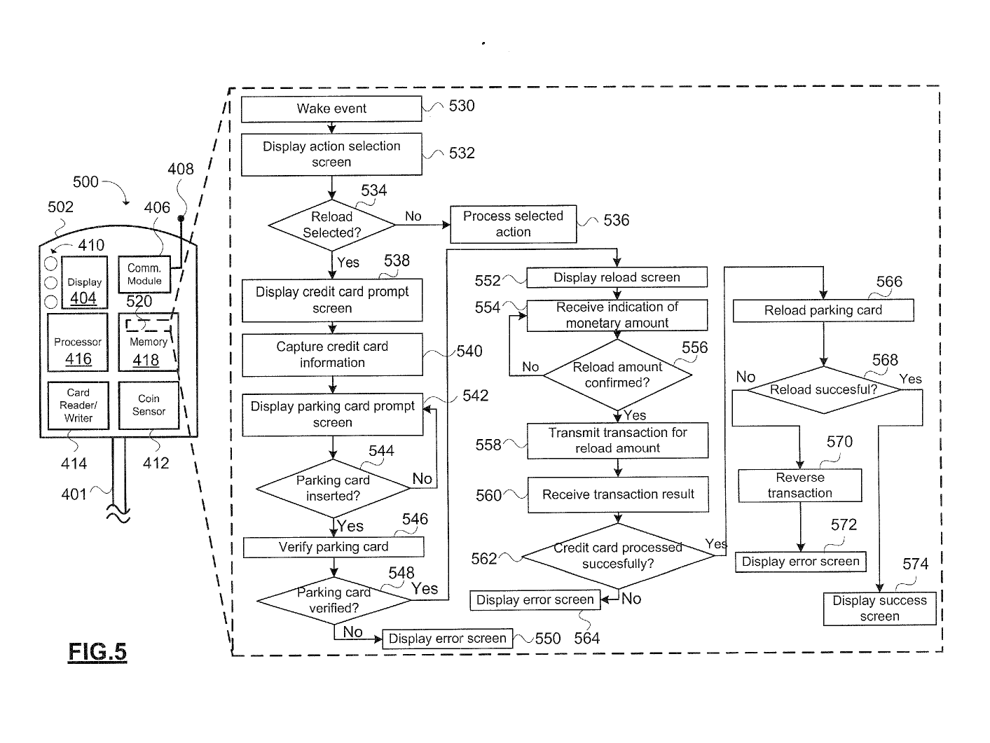

FIG. 5 depicts components of a single space parking meter capable of reloading a parking card. The parking meter 500 comprises the same components as the parking meter 400 described above, and as such the components are not detailed further. However, in contrast to the instructions 420 stored in the memory, the instructions 520 configure the parking meter 400 to provide amore robust reloading of parking cards.

The reloading of the parking card at the parking meter may begin when a wake event occurs (530) at the parking meter. The wake event may arise from an input component 410 being pressed or a card being inserted into the card reader/writer 414. It is noted that the wake event may also result from a coin being detected in the coin chute; however, for practical purposes, the use of coins as payment for reloading a parking card is not considered, although possible, since the number of coins required would likely be large in many transactions, and therefore a less likely means for reloading a parking card. As such, when a coin is detected in single space parking meter 500, the parking meter may assume that parking time is being purchased. When the wake event occurs, the parking meter displays an action selection screen (532) that allows a user to select an action, which may include, for example, paying for parking or reloading a parking card. Each action may be associated with an input component, allowing a user to select the desired action to perform. When a selection is received, it is determined if the selection is for reloading a parking card (534) and if it is not (No at 534) the appropriate action is performed or processed (536) based on the selected option. If reloading a parking card is selected (Yes at 534), a screen is displayed prompting the user to provide the payment card (538). Once the payment prompt screen is displayed, it is assumed that the user will swipe the appropriate payment card for the parking meter to capture associated account information. Although described as swiping a payment card, other methods of accessing the account information may be used or required depending on the type of payment card. Regardless of the specific type of payment card used, the parking meter captures account information from the payment card (540). Once the account information is captured, the parking meter may display a screen prompting the user to insert the parking card to be reloaded (542). The parking meter determines if a parking card has been inserted (544) and if it hasn't (No at 544), it continues to display the prompt screen (542). If a parking card is inserted (Yes at 544), the parking meter may verify the parking card (546). Verifying the parking card may comprise one or more of checking the card to determine an existing monetary amount on the card, checking to verify that the parking card is a valid parking card, and/or checking to verify that the parking card may be written to. Additional verifications of the parking card may be made depending on the requirements of the parking system. It is determined if the parking card was verified (548) successfully, and if it wasn't (No at 548) an error screen indicating the error, or possibly instructing the user to retry inserting the parking card, may be displayed (550). If the parking card was verified (Yes at 548) a reload screen may be displayed (552). The reload screen may provide instructions to the user for incrementing, decrementing or otherwise selecting the monetary amount to be added to the parking card. The parking meter receives an indication of the desired monetary amount to be added to the parking card (554). The monetary amount may be selected, for example by pressing one or more of the input components 410. For example, one input component may be used to increase the amount and another for decreasing it. The parking meter determines if the monetary amount has been confirmed (556). Confirming the monetary amount may include the parking meter displaying a confirmation screen with the monetary amount and requiring the user to press an input component to confirm the amount. If the monetary amount is not confirmed (No at 556) the parking meter may return to display the reload screen (552) to allow the user to select a different monetary amount. If the monetary amount is confirmed (Yes at 556), a transaction, or transaction request, from the account of the payment card for the monetary amount is transmitted to a backend system (558) for processing and authorization. The transmitted transaction, or transaction request, may include additional information, such as an identification of the parking card, a time and date of the transaction, an identification of the parking meter and/or other information as desired or required by the parking system. Once the transaction is transmitted, the backend processes the transaction, for example by authorizing the account for the monetary amount to ensure that the transaction is, or will be, approved. Once the backend processes the transaction, the result is sent back to the parking meter. The transaction result is received by the parking meter (560). The transaction result indicates whether or not the transaction was authorized or not. The parking meter determines if the transaction was authorized or not (562) and if it was not authorized (No at 562), an error screen may be displayed (564). If the transaction was authorized (Yes at 562), the parking meter attempts to reload the parking card with the monetary amount (566). It is possible that the reloading of the parking card may fail, for example the parking meter may not be able to write to the parking card or the parking card may be prematurely removed from the parking meter. The parking meter determines if the reload was successful (568) and if it was not successful (No at 568), the transaction may be reversed (570). Alternatively, the writing to the parking card may be retried. Reversing the transaction may comprise sending a message to the backend system indicating the transaction to be reversed. The backend system may then ensure that the account for which the transaction was authorized is not charged for the transaction. The parking meter may also display an error screen (572) indicating that the reload was not successful. If the reload was successful (Yes at 568), a screen may be displayed indicating the success of the reloading of the parking card.

The above has described reloading a monetary value onto a parking card at a single space parking meter. In addition to the re-load functionality, a single space parking meter may further comprise re-validation functionality. The re-validation functionality of the single space parking meter comprises periodic communication with a remote (central management) system in order for the single space parking meter to receive validation that it may re-load payment cards. For example, the single space parking meter may send a re-validation message to the remote system, and receive a re-validation response message from the remote system indicating whether or not the removable single space parking meter mechanism can load or reload further parking cards. The re-validation may be done at various frequencies, such as once an hour, once a day, once a week, etc. As such, if for example, a parking meter is stolen, the remote system may not provide re-validation to the stolen parking meter, and the reload functionality of the stolen parking meter will be disabled so that it will no longer be able to reload parking cards. Additionally or alternatively, the remote system could send a message to a parking meter that has been identified as being stolen in order to permanently disable the reload functionality of the parking meter.

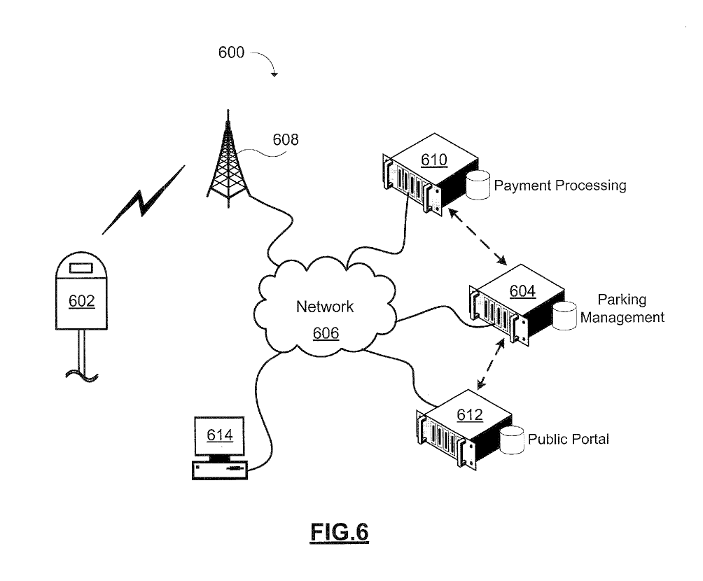

As will be appreciated, single space parking meters do not include a printer, and as such, it is not possible to print a receipt of the transaction. It may be desirable to have access to a receipt of the transaction for various reasons, including, for example, reimbursement purposes, financial management purposes and/or tax purposes. As described further with reference to FIG. 6, it is possible for a parking meter system to provide a receipt of the transaction. In order to provide access to a transaction receipt, the parking meter may display to the user receipt information for accessing a receipt of the transaction. The displayed receipt information may comprise, for example a transaction identifier (ID) uniquely identifying the transaction. A user may use the transaction ID, or other identifying information such as the account information, the date/time, the location or parking meter ID or a unique identifier of the parking card, to access a receipt of the transaction, or access other transaction information, from the backend system.

FIG. 6 depicts a system for providing a transaction receipt for a transaction carried out at a single space parking meter. The system 600 comprises a single space parking meter 602 that is capable of reloading a parking card as described above. Although only one single space parking meter is depicted, it is contemplated that the system 600 would comprise a plurality of single space parking meters. The single space parking meter 602 may communicate with a backend system, depicted in FIG. 6 as a parking management system 604, through a network 606 and a wireless communication infrastructure 608. The system 600 further comprises a payment processing system 610 connected to the network 606 that the parking management system may use to authorize and process transactions. The system 600 may further comprise a public portal 612 connected to the network 606 that provides access to transaction information, and in particular may provide a transaction receipt, to users. A personal computer 614, or other computing device, is also depicted connected to the network 606 and may be used to access a transaction receipt from the public portal 612.

As described above, the single space parking meter 602 may transmit a transaction request to the parking management system 604. The transaction request may comprise a unique identifier identifying the transaction, which may be comprised of multiple elements, such as a unique meter ID, a date of the transaction, and a transaction ID. The parking management system 604 receives and processes the transactions from the single space parking meter 602 using the payment processing system 610. The parking management system 604 receives a result from the payment processing system 610 which is stored. A response may be sent back to the single space parking meter and processed as described above. Regardless of whether the transaction was authorized or not, it may be desirable for the user to access a receipt of the transaction, for example to confirm the amount of the transaction, or confirm that the transaction was not put through and so the account not charged, or was refunded. In displaying the transaction result to the user, additional identifying information may also be displayed which may allow the user to access the transaction receipt.

In order to access a transaction receipt, a user may access the transaction information stored in the parking management system 604 through the public portal 612. The public portal provides an interface for accessing the transaction information, and may comprise a web server that can generate a web page displaying the appropriate transaction information. In order to access the transaction information, which may be printed by the user and used as a transaction receipt, the user accesses the public portal 612 and provides sufficient identifying information to allow the public portal to identify the transaction. The identifying information may be the transaction information displayed by the single space parking meter. Additionally or alternatively, the identifying information may comprise other unique information, or combinations of non-unique information, such as for example, an account identifier associated with the parking card used in the reload transaction, an identification of the account of the payment card used in the transaction, an indication of the date/time the transaction took place, an indication of the location of the single space parking meter, or a parking meter ID.

Once the user provides the identifying information to the public portal 612, the public portal may access the parking management system to retrieve the associated transaction information associated with the identifying information, assuming the identifying information matches a transaction. If the identifying information does not match any transaction, the user may be prompted to provide additional or alternative identifying information. Once a transaction has been identified, the public portal may retrieve the associated transaction information and generate a web page, or other method of displaying the information, such as an e-mail or text message, for presentation to the user. Where a user has an account identifier associated with the parking card used in reload transactions, the user may configure his/her account using the public portal to automatically deliver an e-mail or text message upon each transaction, and/or on a periodic basis. The transaction information presented to the user may indicate for example, the amount charged to the account of the payment card, whether the reload was successful or not, and if the reload was not successful whether or not the reversal of the transaction was successful. Other information that may be presented includes, for example a date, time and location of the transaction. The displayed transaction information may be used as a receipt for the transaction performed at the single space parking meter. In the alternative or in addition to electronic delivery of a receipt(s) and/or transaction information, delivery may be accomplished by way of a paper printout at a business premises of the parking management system that is then sent to a user using traditional mail or courier.

Modifications may be made to the embodiments described above. For example, the above description has described the parking card as a smart card which typically includes electrical contacts enabling communication between the parking meter and the parking card. Additionally or alternatively, the parking card could be provided by a contactless parking card that does not require an electrical connection to be made with the parking meter in order to provide communication. The communication could be provided by near field communication (NFC) techniques. Further, the contactless parking card functionality could be provided by various devices other than a card. For example the parking card functionality and NFC capabilities could be provided in a mobile device such as a cellular phone, a parking tag, a key chain, or other articles.

Various embodiments of single space parking meters with the ability to reload a parking card with a monetary amount have been described. The above-described embodiments of the invention are intended to be examples of the present invention and alterations and modifications may be effected thereto, by those of ordinary skill in the art, without departing from the scope of the invention which is defined solely by the claims appended hereto.

What is claimed is:

1. A removable single space parking meter mechanism comprising:
a card reader for reading a payment card, and reading from and writing to a parking card a monetary value;
a communication module for communicating with a remote system;
a memory for storing instructions; and
a processor for executing the instructions, when executed by the processor, the instructions configuring the removable parking meter mechanism to provide a method of loading or reloading the monetary value to the parking card, the method comprising:
reading account information from the payment card using the card reader;
receiving an indication of the monetary value to load or reload onto the parking card;
communicating with the remote system using the communication module to authorize a transaction using the payment card's account information for the monetary value;
receiving an indication of whether the transaction of the payment card was successful or not; and
attempting to load or reload the monetary value to the parking card when the transaction was successful.

2. The removable single space parking meter mechanism of claim 1, wherein the method further comprises:
detecting an error during the attempt to reload the monetary value to the parking card; and
communicating with the remote system to reverse the transaction using the payment card's account information.

3. The removable single space parking meter mechanism of claim 1, wherein the method further comprises:
determining that the attempt to reload the monetary value to the parking card was successful; and
communicating with the remote system that the reload attempt was successful.

4. The removable single space parking meter mechanism of claim 1, further comprising:
a display for displaying parking information,
wherein the method further comprises:
displaying instructions on the display instructing a user to provide the payment card and the parking card as required during operation of the method.

5. The removable single space parking meter mechanism of claim 1, wherein the communication module comprises a radio frequency (RF) communication module for communicating wirelessly with the remote system.

6. The removable single space parking meter mechanism of claim 5, wherein the RF communication module comprises one or more of:
a cellular radio module;
a WiFi radio module;
a WiMax radio module; and
a Bluetooth radio module.

7. The removable single space parking meter mechanism of claim 1 further comprising:
a coin chute for receiving coins and identifying the coins' denominations.

8. The removable single space parking meter mechanism of claim 1, wherein the method further comprises:
displaying transaction information for accessing a receipt of the transaction from the remote system.

9. The removable single space parking meter mechanism of claim 1, wherein the removable single space parking meter mechanism provides metering for a single parking space.

10. The removable single space parking meter mechanism of claim 1, further comprising an auxiliary display located on a back side of the removable single space parking meter mechanism for displaying a parking status.

11. The removable single space parking meter mechanism of claim 1, wherein the removable single space parking meter mechanism has a lower portion sized to be received within a lower housing having a common form factor.

12. The removable single space parking meter mechanism of claim 4, further comprising at least one input component located adjacent to the display.

13. The removable single space parking meter mechanism of claim 12, wherein the at least one input component located adjacent to the display consists of four input components.

14. The removable single space parking meter mechanism of claim 1, wherein the card reader comprises one or more of:
a magnetic stripe reader;
a smart card reader/writer;
a contactless reader;
a contactless reader and writer.

15. The removable single space parking meter mechanism of claim 1, wherein the method further comprises:
sending a re-validation message to the remote system;
receiving a re-validation response message from the remote system indicating whether or not the removable single space parking meter mechanism can load or reload further parking cards; and
disabling further loading or reloading of the parking card when the received re-validation response message indicates that the removable single space parking meter mechanism cannot load or reload further parking cards.

16. A single space parking meter comprising:
a removable single space parking meter mechanism according to claim 1; and
a protective housing protecting the parking meter mechanism from the environment.

17. The single space parking meter of claim 16, further comprising:
a solar panel coupled to the removable single space parking meter mechanism.

18. The single space parking meter of claim 17, wherein the solar panel is located on a front side of the parking meter.

19. The single space parking meter of claim 17, wherein the solar panel is located on a back side of the parking meter.

20. The single space parking meter of claim 16, wherein a portion of the housing is coupled to the removable parking meter mechanism.

21. The single space parking meter of claim 16, wherein the protective housing comprises a lower housing and a portion that is moveably coupled to the lower housing for securing the removable single space parking meter mechanism within the protective housing.

22. A parking meter system comprising:
a plurality of single space parking meters according to claim 16;
a parking management system capable of wirelessly communicating with the plurality of single space parking meters, the parking management system storing transaction information uniquely identifying transactions carried out at one or more of the plurality of single space parking meters; and
a portal system for receiving identifying information for identifying a transaction in the transaction information and generating a receipt of the identified transaction.

23. The parking meter system of claim 22, wherein the portal system comprises a web-based portal and the receipt is generated as a web page.

24. The parking meter system of claim 22, wherein the receipt is generated as an e-mail, a text message, or a paper printout to be delivered by traditional mail or courier.

25. The parking meter system of claim 22, wherein the identifying information is received from personal computing device.

26. The parking meter system of claim 22, wherein the identifying information comprises one or more of:
account information of an account used for the transaction;
a location of the parking meter of the transaction;
a unique parking meter identifier of the parking meter of the transaction;
a date of the transaction;
a status of the transaction;
an approximate time of the transaction; and
a value of the transaction.

27. A method for providing a transaction receipt for a single space parking meter, the method comprising:
carrying out a transaction at a single space parking meter according to claim 16, the transaction associated with transaction information uniquely identifying the transaction;
communicating the transaction information to a remote server;
storing the transaction information;
receiving a request for a transaction receipt, the request comprising at least a portion of the transaction information uniquely identifying the transaction;
retrieving the transaction information based on the portion of the transaction information received with the request;
generating the transaction receipt from the retrieved transaction information; and
providing the transaction receipt.

28. The method of claim 27, wherein the transaction information includes one or more of:
account information of an account used for the transaction;
a location of the parking meter of the transaction;
a unique parking meter identifier of the parking meter of the transaction;
a date of the transaction;
a status of the transaction;
an approximate time of the transaction; and
a value of the transaction.

29. The method of claim 27, wherein the receipt is provided by way of one or more of a web page, an e-mail, a text message, or a paper printout delivered by traditional mail or courier.
